(19) United States
(12) Patent Application Publication
(10) Pub. No.: US 2005/0263568 A1
(43) Pub. Date: Dec. 1, 2005

(54) Method and product for joining tubes of dissimilar metals

(76) Inventor: Israel Stol, Pittsburgh, PA (US)

Correspondence Address: ECKERT SEAMANS CHERIN & MELLOTT, LLC;ALCOA TECHNICAL CENTER, 100 TECHNICAL DRIVE, ALCOA CENTER, PA, 15069-0001, US

(21) Appl. No.: 10/855,027

(22) Filed: May 26, 2004

(51) Int. Cl. B23K 20/08

(52) U.S. Cl. 228/107; 228/170

(57) ABSTRACT

A method and product for joining a first tube comprised of a first metal to a second tube comprised of a second metal, the metals being metallurgically incompatible. A layered plate is produced having a first layer compatible with the first metal, a second layer compatible with the second metal and a third layer between the first layer and the second layer; the third layer being compatible with both the first layer the second layer. A hole is drilled in the first layer to receive the first tube and a hole is drilled in the second layer to receive the second tube, the holes communicating with each other. A coupler is excised from the plate, the coupler including the first hole and the second hole. The first and second tubes are soldered, brazed or welded into their corresponding holes to connect the first tube to the second tube.

### FIELD OF THE INVENTION

The present invention pertains to welding, brazing or soldering dissimilar metals, and, more particularly, it pertains to joining copper tubes to aluminum tubes.

### BACKGROUND OF THE INVENTION

It is known that various difficulties are encountered when it is desired to produce a metallurgical bond between copper and aluminum. One difficulty is that the melting point of aluminum is 933.5 K and the melting point of copper is 1356.6 K. Another difficulty is that the oxide layer on aluminum is difficult to remove, making it difficult to bring any brazing or soldering composition into direct metal to metal contact with the aluminum. The high thermal conductivity of both aluminum and copper makes it difficult to provide localized heat to the juncture between aluminum and copper.

A further difficulty is that an aluminum copper junction tends to form precipitated particles of intermetallaic aluminum-copper compounds. These intermetallics are brittle, and tend to produce a brittle joint. U.S. Pat. No. 4,224,499: Laser Welding Aluminum to Copper teaches an interesting approach to eliminating intermetallics. An aluminum conductor and a copper conductor are pressed together with a predetermined contact pressure. A brief laser pulse is directed at the juncture of the aluminum and copper. The laser causes melting of the aluminum and copper, and the pressure causes most of the molten material to be ejected. Intermetallic Al—Cu compounds are found in the ejected material, but the joint between aluminum and copper, although it is a fused connection, is generally free of intermetallics.

U.S. Pat. No. 5,549,335: Solderless Metallurgical Joint teaches joining an aluminum tube to a copper tube. An end portion of the copper tube is swaged and tapered to fit inside the end of the aluminum tube, and an end portion of the aluminum tube may be flared to receive the copper tube. Induction heating is applied to bring least one of the tubes to a temperature above the eutectic temperature of aluminum and copper. The two tubes are then forced together with a predetermined force. The result is a metallurgical bond comprising a layer of the aluminum-copper eutectic between the aluminum and the copper.

U.S. Pat. No. 5,338,072: Gastight Connection between Tubes of Small Diameter teaches joining an aluminum tube to a copper tube. In this case, the aluminum tube fits inside the copper tube. The steps of fluxing and soldering are used to obtain a metallurgical bond. This patent teaches the option of employing a sleeve of high melting point metal such as steel between the copper and the aluminum. This patent speaks of the difficulty of making such connections in the field. In particular, the difficulty of preventing an internal bead that would impede fluid flow is cited.

U.S. Pat. No. 6,149,049: Metallurgical Bonding of Dissimilar Metal Tubes teaches the use of a connecting member comprised of concentric metallurgically bonded tubes. In particular, it teaches a method for joining a copper tube to a titanium tube. A connecting member comprising metallurgically bonded concentric copper and titanium portions is placed between the two tubes. The titanium portion of the connecting member is welded to the titanium tube and the copper portion of the connecting member is soldered to the copper tube.

Various other patents describe explosive bonding of sheets of dissimilar metals. In particular, U.S. Pat. No. 4,925,084: Method of Explosion Welding of Alloy Aluminum teaches a method for bonding magnesium-alloyed aluminum sheets to sheets of high strength materials. The patent teaches limiting the pressures produced by the explosion to prevent magnesium in the aluminum from vaporizing.

Other patents teaching explosive bonding include U.S. Pat. No. 4,756,464, U.S. Pat. Nos. 4,747,350, and 3,137,937. Furthermore the teachings of the patents cited above are hereby incorporated into the present patent application by reference thereto.

### INTRODUCTION TO THE INVENTION

The principal objective of the present invention is to provide for leak proof seals between tubing comprised of dissimilar metals.

It is a further objective of the present invention to provide a simple and reliable method for joining tubes of dissimilar metals “in the field” at the customer's site. Although, in the factory, such joints could have been made mechanically, brazed, soldered or explosively-bonded, in the field the repair procedure must be:
Relatively simple to perform;
Easy to train and qualify the maintenance/repair personnel in the field;
Effective in consistently sealing the joints from leakage from inside out or outside in, in the case of evacuated systems;
Yield joints that do not deteriorate over time due to metallurgical effects;
Require simple and cheap equipment to implement (e.g., torch and fluxes);
Dependable and consistent; and
Afford access to the affected areas, without disrupting and/or compromising the integrity of the adjoining components.

In particular, it is difficult to obtain a good metallurgical bond between aluminum and copper. Furthermore, a direct metallurgical bond between aluminum and copper is subject to deterioration with time because diffusion at the boundary between the aluminum and the copper may enable the creation of intermetallic compounds of aluminum and copper, which are brittle.

It is, accordingly, an objective of the present invention to provide a bimetallic coupler for joining a tube of a first metal to a tube of a second metal. A first portion of the coupler is comprised of or compatible with the first metal and a second portion of the coupler is comprised of or compatible with the second metal.

It is another objective of the present invention to provide a coupler for joining two metallurgically incompatible metals.

It is yet another objective of the present invention to provide a coupler which may be employed in the field to join tubing comprised of two metallurgically incompatible metals.

It is an additional objective of the present invention to provide a coupler for joining dissimilar metal tubes wherein the joining processes can be performed without inadvertently obstructing the tubes by brazing, soldering or welding materials.

A further objective of the present invention is to provide a coupler for joining a first tube comprised of a first metal to a second tube comprised of a second metal, the first metal and the second metal being metallurgically incompatible. The coupler has first and second portions for connection to the first and second tubes, respectively, and it has a third portion comprised of a third metal disposed between the first portion and the second portion, the third portion acting as a diffusion barrier between the first metal and the second metal.

### SUMMARY OF THE INVENTION

In one aspect, the present invention is a method of joining a first tube comprised of a first metal to a second tube comprised of a second metal. The method includes metallurgically bonding a first plate or sheet comprised of the first metal or a metal metallurgically compatible with the first metal to a second plate or sheet comprised of the second metal or a metal metallurgically compatible with the second metal to make a laminated plate or sheet comprising a first layer of the first metal or a metal similar to the first metal metallurgically bonded to a second layer of the second metal or a metal similar to the second metal. The first layer is drilled to form a first clearance hole for the first tube, and the second layer is drilled to form a second clearance hole for the second tube, the second clearance hole being substantially coaxial with the first clearance hole, the second clearance hole communicating with the first clearance hole. The laminated plate or sheet is cut or milled to excise a coupler for joining the first tube to the second tube, the coupler including the first clearance hole and the second clearance hole. The first tube is then inserted into the first clearance hole, where it is soldered, brazed or welded, and the second tube is inserted into the second clearance hole, where it is soldered, brazed or welded.

In another aspect, the present invention is a method of joining a first tube comprised of a first metal to a second tube comprised of a second metal, the first metal and the second metal being metallurgically incompatible. The method includes obtaining a first plate or sheet comprised of the first metal or a metal metallurgically compatible with the first metal, obtaining a second plate or sheet comprised of the second metal or a metal metallurgically compatible with the second metal, and obtaining a third plate or sheet comprised of a third metal, the third metal being metallurgically compatible with the first metal and the third metal being metallurgically compatible with the second metal. The third plate or sheet is placed between the first plate or sheet and the second plate or sheet. The third plate or sheet is then metallurgically bonded to the first plate or sheet and to the second plate or sheet to make a laminated plate or sheet having a first layer comprised of the first metal or a metal similar to the first metal, a second layer comprised of the second metal or a metal similar to the second metal, and a third layer comprised of the third metal, the third layer being interposed between the first layer and the second layer. The method further includes drilling the first layer to form a first clearance hole for the first tube and drilling the second layer to form a second clearance hole for the second tube, the second clearance hole being substantially coaxial with the first clearance hole, the second clearance hole communicating with the first clearance hole. The method further includes cutting or milling the laminated plate or sheet to excise a coupler for joining the first tube to the second tube, the coupler including the first clearance hole and the second clearance hole. The first tube is then inserted into the first clearance hole and soldered, brazed or welded to the coupler, and the second tube is inserted into the second clearance hole and soldered, brazed or welded to the coupler.

In an additional aspect, the present invention is a coupler for joining a first tube of a first metal to a second tube of a second metal, the first metal being dissimilar to the second metal. The coupler includes a first coupler portion comprised of the first metal or a metal compatible with the first metal and a second coupler portion comprised of the second metal or a metal compatible with the second metal. The first coupler portion is metallurgically bonded to the second coupler portion. A first clearance hole for the first tube is disposed in the first coupler portion and a second clearance hole for the second tube is disposed in the second coupler portion, the second clearance hole communicating with the first clearance hole. The end user may then solder, braze or weld the first tube into the first clearance hole and solder, braze or weld the second tube into the second clearance hole, so that a leak proof connection is provided between the first tube and the second tube.

In yet another aspect, the present invention is a coupler for joining a first tube of a first metal to a second tube of a second metal, the first metal being metallurgically incompatible with the second metal. The coupler includes a first coupler portion comprised of the first metal or a metal similar to the first metal, a second coupler portion comprised of the second metal or a metal similar to the second metal, and a third coupler portion comprised of a third metal; the third metal being metallurgically compatible with the first metal and the third metal being metallurgically compatible with the second metal, the third coupler portion being interposed between the first coupler portion and the second coupler portion. The first coupler portion is metallurgically bonded to the third coupler portion and the second coupler portion is metallurgically bonded to the third coupler portion. A first clearance hole for the first tube is in the first coupler portion and a second clearance hole for the second tube is in the second coupler portion, the second clearance hole communicating with the first clearance hole through the third coupler portion. The end user may then solder, braze or weld the first tube into the first clearance hole and solder, braze or weld the second tube into the second clearance hole, so that a leak proof connection is provided between the first tube and the second tube.

### BRIEF DESCRIPTION OF THE DRAWINGS

FIG. 1 is a schematic section of two plates or sheets comprised of dissimilar metals prior to metallurgical bonding;

FIG. 2 is a schematic section of a plate or sheet comprised of two layers produced by metallurgically bonding the plates or sheets illustrated in FIG. 1;

FIG. 3 is a schematic section of a coupler cut from the plate or sheet illustrated in FIG. 2, the coupler joining two tubes of dissimilar metals by soldering or brazing;

FIG. 4 is a schematic section of a coupler cut from the plate or sheet illustrated in FIG. 2, the coupler joining two tubes of dissimilar metals by welding;

FIG. 5 is a schematic section of three plates or sheets comprised of dissimilar metals prior to metallurgical bonding;

FIG. 6 is a schematic section of a plate or sheet comprised of three layers produced by metallurgically bonding the plates or sheets illustrated in FIG. 5;

FIG. 7 is a schematic section of a coupler cut from the plate or sheet illustrated in FIG. 6, the coupler joining two tubes of metallurgically incompatible metals by soldering or brazing; and

FIG. 8 is a schematic section of a coupler cut from the plate or sheet illustrated in FIG. 6, the coupler joining two tubes of metallurgically incompatible metals by welding.

### DETAILED DESCRIPTION OF PREFERRED EMBODIMENTS

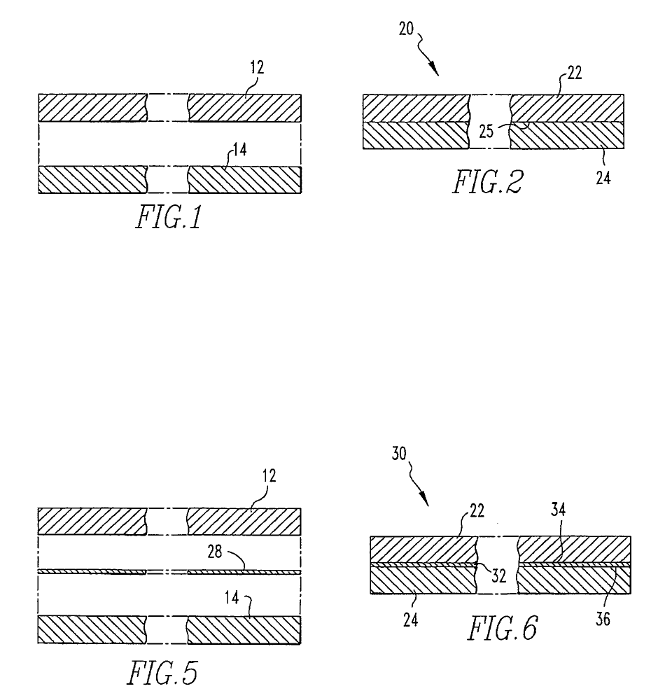

FIG. 1 shows the materials employed for producing some embodiments of the present invention, which are for joining a first tube comprised of a first metal to a second tube comprised of a second metal. A first plate or sheet comprised of the first metal or a metal compatible with the first metal is denoted 12 and a second plate or sheet comprised of the second metal or a metal compatible with the second metal is denoted 14. FIG. 2 illustrates a laminated plate or sheet comprising two layers. Layer 22 is made from plate or sheet 12 and is comprised of or compatible with the first metal, and layer 24 is made from plate or sheet 14 comprised of or compatible with the second metal. The first layer 22 and the second layer 24 are metallurgically bonded at the interface 25. Metallurgical bonding is preferably accomplished by explosive welding, also known as explosive bonding, or by hot rolling. The term “metallurgically bonded” as employed herein signifies a connection between dissimilar metals which is largely free of oxide layers, contaminants or brittle intermetallic compounds so that the metals are in direct metal-to-metal contact and are not embrittled.

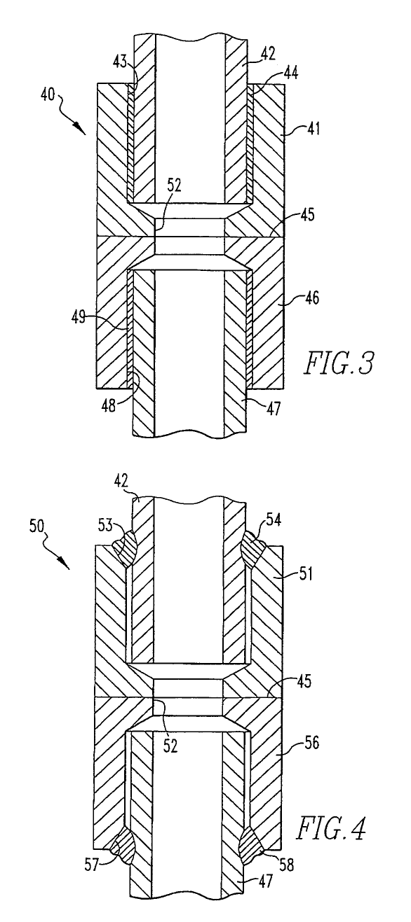

FIG. 3 illustrates a coupler 40 which is produced from the laminated plate or sheet 20 illustrated in FIG. 2. Coupler 40 is for connecting a tube 42 comprised of the first metal to a tube 47 which is comprised of the second metal. To make coupler 40, clearance hole 43 is drilled into layer 22 of the laminated plate or sheet 20 to accommodate tube 42 and clearance hole 48 is drilled into layer 24 of the laminated plate or sheet 20 to accommodate tube 47. Clearance hole 43 communicates with clearance hole 48. Preferably, communication between clearance hole 43 and clearance hole 48 is provided by alignment hole 52. The alignment hole 52, preferably, has a diameter at least equal to about the inside diameter of first tube 42 or second tube 47. The alignment hole 52 may be employed for aligning the last drilled of clearance holes 43 and 48 with the first drilled of clearance holes 43 and 48.

Coupler 40, preferably, is excised out of the laminated plate or sheet 20 after the alignment hole 52, the first clearance hole 43 and the second clearance hole 48 are drilled. Coupler 40 may be then employed to facilitate or enable the joining of first tube 42 comprised of the first metal to the second tube 47 comprised of the second metal. In particular, coupler 40 may be employed in the field, i.e. at a customer's location. Preferably, coupler 40 is excised out of the laminated plate or sheet 20 by a hole saw or a trepanning tool.

FIG. 3 shows first tube 42 attached to coupler 40 by the first brazed or soldered connection 44, and it shows the second tube 47 attached to coupler 40 by the second brazed or soldered connection 49. A person skilled in the art will recognize that the diameter of first clearance hole 43 should be sufficiently great that the liquid solder or brazing material will be drawn into the space between first tube 42 and first clearance hole 43 by capillarity. Such a person will also recognize that the diameter of clearance hole 43 should be small enough that the liquid solder or brazing material will not tend to form a bead inside of tube 42 or inside alignment hole 52; being held in the space between first tube 42 and first clearance hole 43 by capillarity.

In like manner, the diameter of second clearance hole 48 should be sufficiently great that the liquid solder or brazing material will be drawn into the space between second tube 47 and second clearance hole 48 by capillarity. Also, the diameter of clearance hole 48 should be small enough that the liquid solder or brazing material will not tend to form a bead inside of tube 47 or inside alignment hole 52; being held in the space between second tube 47 and second clearance hole 48 by capillarity.

In a presently preferred embodiment for this configuration, the first metal is aluminum or an aluminum alloy and the second metal is titanium or a titanium alloy.

FIG. 4 illustrates a coupler 50 which is similar to coupler 40, except that tubes 42 and 47 are to be joined by welding. Tube 42 is joined to first coupler portion 51 by first weld 54 and tube 47 is joined to second coupler portion 56 by second weld 58. Preferably, at the time that coupler 50 is made, chamfer 53 is cut into first coupler portion 51 to facilitate the forming of first weld 54. Likewise, chamfer 57 is cut into second coupler portion 56 to facilitate second weld 58. Like coupler 40, coupler 50 is, preferably, excised out of laminated plate or sheet 20 by a hole saw or a trepanning tool.

FIG. 5 shows the materials employed for producing embodiments of the present invention which are for joining a first tube comprised of a first metal to a second tube comprised of a second metal, the first metal and the second metal being metallurgically incompatible. A first plate or sheet comprised or compatible with the first metal is denoted 12 and a second plate or sheet comprised of or compatible with the second metal is denoted 14. A third plate or sheet 28 comprised of a third metal is disposed between the first plate or sheet 12 and the second plate or sheet 14. The third metal is chosen to be metallurgically compatible with the first metal, and also to be metallurgically compatible with the second metal.

FIG. 6 illustrates a laminated plate or sheet 30 produced by metallurgically bonding the three sheets or plates 12, 14 and 28 illustrated in FIG. 5. Preferably, metallurgical bonding is accomplished by explosive welding, or by hot rolling.

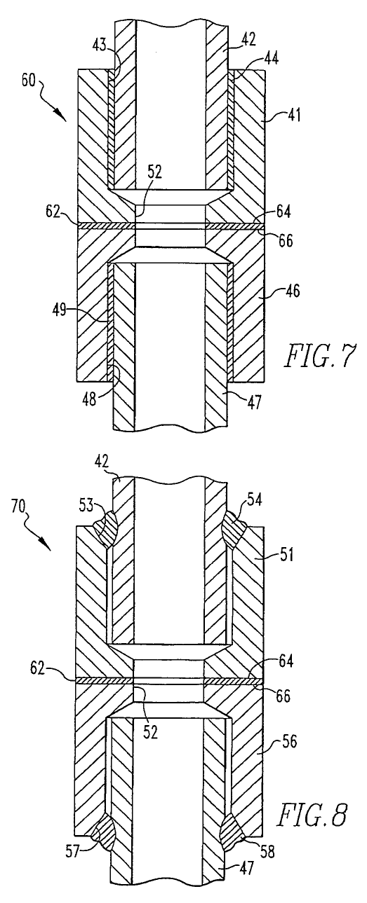

FIG. 7 illustrates a coupler 60 which is produced from the laminated plate or sheet 30 illustrated in FIG. 6. Coupler 60 is for connecting a first tube 42 comprised of a first metal to a second tube 47, comprised of a second metal, the first metal being metallurgically incompatible with the second metal. To make coupler 60, clearance hole 43 is drilled into layer 22 of plate or sheet 30 to accommodate tube 42 and clearance hole 48 is drilled into layer 24 of sheet 30 to accommodate tube 47. Clearance hole 43 communicates with clearance hole 48. Preferably, communication between clearance hole 43 and clearance hole 48 is provided by alignment hole 52. The alignment hole 52, preferably, has a diameter at least equal to about the inside diameter of first tube 42 or second tube 47. The alignment hole 52 may be employed for aligning the last drilled of clearance holes 43 and 48 with the first drilled of clearance holes 43 and 48.

Coupler 60, preferably, is excised out of the laminated plate or sheet 30 after the alignment hole 52, the first clearance hole 43 and the second clearance hole 48 are drilled. Coupler 60 may be then employed to facilitate or enable the joining of first tube 42 comprised of the first metal to the second tube 47 comprised of the second metal. In particular, coupler 60 may be employed in the field, i.e. at a customer's location. Preferably, coupler 60 is excised out of the laminated plate or sheet 20 by a hole saw or a trepanning tool.

FIG. 7 shows first tube 42 attached to coupler 60 by the first brazed or soldered connection 44, and it shows the second tube 47 attached to coupler 60 by the second brazed or soldered connection 49. A person skilled in the art will recognize that the diameter of clearance hole 43 should be sufficiently great that the liquid solder or brazing material will be drawn into the space between first tube 42 and first clearance hole 43 by capillarity. Such a person will also recognize that the diameter of clearance hole 43 should be small enough that the liquid solder or brazing material will not tend to form a bead inside of tube 42 or inside alignment hole 52; being held in the space between first tube 42 and first clearance hole 43 by capillarity.

In like manner, the diameter of second clearance hole 48 should be sufficiently great that the liquid solder or brazing material will be drawn into the space between second tube 47 and second clearance hole 48 by capillarity. Also, the diameter of second clearance hole 48 should be small enough that the liquid solder or brazing material will not tend to form a bead inside of tube 47 or inside alignment hole 52; being held in the space between second tube 42 and second clearance hole 48 by capillarity.

In the presently preferred embodiment for this configuration, the first tube is aluminum or an aluminum alloy, the second metal is copper or a copper alloy, and the third metal is titanium or a titanium alloy.

FIG. 8 illustrates a coupler 70 which is similar to coupler 60, except that tubes 42 and 47 are to be joined by welding. Tube 42 is joined to first coupler portion 51 by first weld 54 and tube 47 is joined to second coupler portion 56 by second weld 58. Preferably, at the time that coupler 70 is made, chamfer 53 is cut into first coupler portion 51 to facilitate the forming of first weld 54. Likewise, chamfer 57 is cut into second coupler portion 56 to facilitate second weld 58. Like coupler 60, coupler 70 is, preferably, excised out of laminated plate or sheet 20 by a hole saw or a trepanning tool.

It is noted that the detailed description of the presently preferred embodiments of the invention presented above is to be considered as illustrative and not restrictive and that the invention may be otherwise embodied within the scope of the appended claims.

1. A method of joining a first tube comprised of a first metal to a second tube comprised of a second metal, said method comprising:
metallurgically bonding a first plate or sheet comprised of or metallurgically compatible with said first metal to a second plate or sheet comprised of or metallurgically compatible with said second metal to make a laminated plate or sheet comprising a first layer comprised of or metallurgically compatible with said first metal and a second layer comprised of or metallurgically compatible with said second metal, said second layer being metallurgically bonded to said first layer;
drilling said first layer to form a first clearance hole for said first tube;
drilling said second layer to form a second clearance hole for said second tube, said second clearance hole being substantially coaxial with said first clearance hole, said second clearance hole communicating with said first clearance hole;
cutting or milling said laminated plate or sheet to excise a coupler for joining said first tube to said second tube, said coupler including said first clearance hole and said second clearance hole;
inserting said first tube into said first clearance hole;
soldering, brazing or welding said first tube to said coupler;
inserting said second tube into said second clearance hole; and
soldering, brazing or welding said second tube to said coupler.

2. The method of claim 1 wherein said step of metallurgically bonding said first plate or sheet to said second plate or sheet comprises explosive welding.

3. The method of claim 1 wherein said step of metallurgically bonding said first plate or sheet to said second plate or sheet comprises hot rolling.

4. The method of claim 1 wherein said first tube and said first plate or sheet comprise aluminum or an aluminum alloy.

5. The method of claim 1 wherein said second tube and said second plate or sheet comprise titanium or a titanium alloy.

6. The method of claim 1 wherein said first tube and said first plate or sheet comprise aluminum or an aluminum alloy and said second tube and said second plate or sheet comprise titanium or a titanium alloy.

7. The method of claim 1 wherein a second drilled of said first clearance hole and said second clearance hole is aligned by an alignment hole, said alignment hole having a diameter at least about as great as an inner diameter of said first tube or an inner diameter of said second tube, whereby after said first clearance hole, said alignment hole and said second clearance hole are drilled, said first clearance hole, said second clearance hole and said alignment hole are substantially aligned.

8. The method of claim 1 wherein said step of cutting or milling said laminated plate or sheet to excise said coupler is performed by a hole saw.

9. The method of claim 1 wherein said step of cutting or milling said laminated plate or sheet to excise said coupler is performed by a trepanning tool.

10. The method of claim 1 wherein a depth of said first clearance hole exceeds a diameter of said first clearance hole.

11. The method of claim 1 wherein a depth of said second clearance hole exceeds a diameter of said second clearance hole.

12. A method of joining a first tube comprised of a first metal to a second tube comprised of a second metal, said first metal and said second metal being metallurgically incompatible, said method comprising:
obtaining a first plate or sheet comprised of or metallurgically compatible with said first metal;
obtaining a second plate or sheet comprised of or metallurgically compatible with said second metal;
obtaining a third plate or sheet comprised of a third metal, said third metal being metallurgically compatible with said first metal and said third metal being metallurgically compatible with said second metal;
placing said third plate or sheet between said first plate or sheet and said second plate or sheet;
metallurgically bonding said first plate or sheet to said third plate or sheet and metallurgically bonding said second plate or sheet to said third plate or sheet to make a laminated plate or sheet having a first layer comprised of or metallurgically compatible with said first metal, a second layer comprised of or metallurgically compatible with said second metal, and a third layer comprised of said third metal, said third layer being interposed between said first layer and said second layer, said third layer acting as a diffusion barrier between said first layer and said second layer;
drilling said first layer to form a first clearance hole for said first tube;
drilling said second layer to form a second clearance hole for said second tube, said second clearance hole being substantially coaxial with said first clearance hole, said second clearance hole communicating with said first clearance hole;
cutting or milling said laminated plate or sheet to excise a coupler for joining said first tube to said second tube, said coupler including said first clearance hole and said second clearance hole;
inserting said first tube into said first clearance hole;
soldering, brazing or welding said first tube to said coupler;
inserting said second tube into said second clearance hole; and
soldering, brazing or welding said second tube to said coupler.

13. The method of claim 12 wherein said step of metallurgically bonding said first plate or sheet to said third plate or sheet and metallurgically bonding said second plate or sheet to said third plate or sheet comprises explosive welding.

14. The method of claim 12 wherein said step of metallurgically bonding said first plate or sheet to said third plate or sheet and metallurgically bonding said second plate or sheet to said third plate or sheet comprises hot rolling.

15. The method of claim 12 wherein a second drilled of said first clearance hole and said second clearance hole is aligned by an alignment hole, said alignment hole having a diameter at least about as great as an inner diameter of said first tube or an inner diameter of said second tube, whereby after said first clearance hole, said alignment hole and said second clearance hole are drilled, said first clearance hole, said second clearance hole and said alignment hole are substantially aligned.

16. The method of claim 12 wherein said step of cutting or milling said laminated plate or sheet to excise said coupler is performed by a hole saw.

17. The method of claim 12 wherein said step of cutting or milling said laminated plate or sheet to excise said coupler is performed by a trepanning tool.

18. The method of claim 12 wherein said first metal is aluminum or an aluminum alloy, and said third metal is titanium or a titanium alloy.

19. The method of claim 12 wherein said second metal is copper or a copper alloy and said third metal is titanium or a titanium alloy.

20. The method of claim 12 wherein said first metal is aluminum or an aluminum alloy, said second metal is copper or a copper alloy, and said third metal is titanium or a titanium alloy, whereby said titanium prevents embrittlement between said aluminum or aluminum alloy and said copper or copper alloy.

21. A coupler for joining a first tube of a first metal to a second tube of a second metal, said first metal being dissimilar to said second metal, said coupler comprising:
a first coupler portion comprised of said first metal or a metal metallurgically compatible with said first metal;
a second coupler portion comprised of said second metal or a metal metallurgically compatible with said second metal;
a first clearance hole for said first tube in said first coupler portion;
a second clearance hole for said second tube in said second coupler portion, said second clearance hole communicating with said first clearance hole;
said first coupler portion being metallurgically bonded to said second coupler portion;
whereby said first tube may be soldered, brazed or welded into said first clearance hole in said first coupler portion; and
whereby said second tube may be soldered, brazed or welded into said second clearance hole in said second coupler portion, so that a leak proof connection is provided between said first tube and said second tube.

22. The coupler of claim 21 wherein said first coupler portion and said second coupler portion are excised from a plate comprised of a first layer comprised of said first metal or said metal metallurgically compatible with said first metal and a second layer comprised of said second metal or said metal metallurgically compatible with said second metal, said first layer and said second layer being metallurgically bonded by explosive welding.

23. The coupler of claim 21 wherein said first coupler portion and said second coupler portion are excised from a plate comprised of a first layer comprised of said first metal or said metal metallurgically compatible with said first metal and a second layer comprised of said second metal or said metal metallurgically compatible with said second metal, said first layer and said second layer being metallurgically bonded by hot rolling.

24. The coupler of claim 21 wherein said first metal is aluminum or an aluminum alloy.

25. The coupler of claim 21 wherein said second metal is titanium or a titanium alloy.

26. The coupler of claim 21 wherein said first metal is aluminum or an aluminum alloy and said second metal is titanium or a titanium alloy.

27. A coupler for joining a first tube of a first metal to a second tube of a second metal, said first metal being metallurgically incompatible with said second metal, said coupler comprising:
a first coupler portion comprised of said first metal or a metal metallurgically compatible with said first metal;
a second coupler portion comprised of said second metal or a metal metallurgically compatible with said second metal;
a third coupler portion comprised of a third metal, said third metal being metallurgically compatible with said first metal and said third metal being metallurgically compatible with said second metal, said third coupler portion being interposed between said first coupler portion and said second coupler portion, said third coupler portion acting as a diffusion barrier between said first coupler portion and said second coupler portion;
said first coupler portion being metallurgically bonded to said third coupler portion;
said second coupler portion being metallurgically bonded to said third coupler portion;
a first clearance hole for said first tube in said first coupler portion; and
a second clearance hole for said second tube in said second coupler portion, said second clearance hole communicating with said first clearance hole through said third coupler portion.

28. The coupler of claim 27 wherein said first coupler portion, said second coupler portion and said third coupler portion are excised from a plate comprised of a first layer comprised of said first metal or said metal metallurgically compatible with said first metal, a second layer comprised of said second metal or said metal metallurgically compatible with said second metal and a third layer comprised of said third metal, said third layer being interposed between said first layer and said second layer; and said third layer being metallurgically bonded by explosive welding to said first layer and to said second layer.

29. The coupler of claim 27 wherein said first coupler portion, said second coupler portion and said third coupler portion are excised from a plate comprised of a first layer comprised of said first metal or said metal metallurgically compatible with said first metal, a second layer comprised of said second metal or said metal metallurgically compatible with said second metal and a third layer comprised of said third metal, said third layer being interposed between said first layer and said second layer; and said third layer being metallurgically bonded by hot rolling to said first layer and to said second layer.

30. The coupler of claim 27 wherein said first metal is aluminum or an aluminum alloy.

31. The coupler of claim 27 wherein said second metal is copper or a copper alloy.

32. The coupler of claim 27 wherein said third metal is titanium or a titanium alloy.

33. The coupler of claim 27 wherein said first metal is aluminum or an aluminum alloy, said second metal is copper or a copper alloy, and said third metal is titanium or a titanium alloy, whereby said titanium prevents embrittlement between said aluminum or aluminum alloy and said copper or copper alloy.
